(19) United States
(12) Patent Application Publication
(10) Pub. No.: US 2022/0357451 A1
(43) Pub. Date: Nov. 10, 2022

(54) LIDAR TRANSMITTER/RECEIVER ALIGNMENT

(71) Applicant: WAYMO LLC, Mountain View, CA (US)

(72) Inventors: Blaise GASSEND, Mountain View, CA (US); Zachary MORRISS, Mountain View, CA (US); Drew ULRICH, Mountain View, CA (US); Pierre-Yves DROZ, Mountain View, CA (US); Ryan DAVIS, Mountain View, CA (US)

(21) Appl. No.: 17/434,942

(22) PCT Filed: Mar. 5, 2020
(86) PCT No.: PCT/US2020/021072

§ 371 Date: Aug. 30, 2021

Related U.S. Application Data
(60) Provisional application No. 62/814,064, filed on Mar. 5, 2019.

(51) Int. Cl. G01S 17/86; G01S 7/481; G01S 17/931; G01S 7/497

(52) U.S. Cl. CPC G01S 17/86; G01S 7/4814; G01S 7/4816; G01S 17/931; G01S 7/4972

(57) ABSTRACT

A light detection and ranging (LIDAR) device includes a transmitter, a receiver, and a minor. The transmitter emits collimated transmit light toward the minor for reflection into an environment. The receiver includes a receive lens, an aperture, a holder, and a light sensor. The receive lens is configured to receive, via the minor, reflections of the collimated transmit light from the environment and focus the received light at a point within the aperture. The holder is configured to position the light sensor to receive light that diverges from the aperture. The holder and aperture can be moved together relative to the receive lens as an assembly. To align the receiver with the transmitter, a light source emits light through the aperture toward the receive lens, and the assembly is adjusted so that the light emitted by the transmitter and receiver overlap m an image obtained by a camera.

### CROSS-REFERENCE TO RELATED APPLICATIONS

This application claims priority to U.S. Provisional Patent Application No. 62/814,064, filed Mar. 5, 2019, which is incorporated herein by reference.

### BACKGROUND

A conventional Light Detection and Ranging (LIDAR) system may utilize a light-emitting transmitter to emit light pulses into an environment. Emitted light pulses that interact with (e.g., reflect from) objects in the environment can be received by a receiver that includes a photodetector. Range information about the objects in the environment can be determined based on a time difference between an initial time when a light pulse is emitted and a subsequent time when the reflected light pulse is received.

### SUMMARY

The present disclosure generally relates to LIDAR devices and systems and methods that can be used when fabricating LIDAR devices. Example embodiments include methods and systems for aligning a receiver of a LIDAR device with a transmitter of the LIDAR device.

In a first aspect, a LIDAR device is provided. The LIDAR device includes a transmitter and a receiver. The transmitter includes a laser diode, a fast-axis collimator optically coupled to the laser diode, and a transmit lens optically coupled to the fast-axis collimator. The transmit lens is configured to at least partially collimate light emitted by the laser diode through the fast-axis collimator to provide transmit light along a first optical axis. The receiver includes a receive lens, a light sensor, and an assembly that includes an aperture and a holder. The receive lens is configured to receive light along a second optical axis that is substantially parallel to the first optical axis and focus the received light. The aperture is proximate to a focal plane of the receive lens, and the holder is configured to hold the light sensor at a position relative to the aperture such that the light sensor receives light that diverges from the aperture after being focused by the receive lens. In this regard, the aperture may be located between the receive lens and the light sensor. The assembly is adjustable relative to the receive lens.

In a second aspect, a method is provided. The method involves arranging a camera and an optical system such that at least a portion of the optical system is within a field of view of the camera. The optical system includes: a first light source; a first lens optically coupled to the first light source, wherein the first lens is configured to collimate light emitted by the first light source to provide a first beam of collimated light; a second light source; an assembly that includes an aperture and a holder, wherein the holder holds the second light source in a position such that the second light source emits light through the aperture; and a second lens optically coupled to the aperture, wherein the second lens is configured to collimate light emitted by the second light source through the aperture to provide a second beam of collimated light. The assembly is adjustable relative to the second lens. The method further involves using the camera to obtain one or more images, wherein the one or more images show a respective first spot indicative of the first beam of collimated light and a respective second spot indicative of the second beam of collimated light. The camera is used to obtain one or more images of the first and second spots.

In a third aspect, a system is provided. The system includes a first light source, a first lens, a second light source, a second lens, an assembly, and a camera. The first lens is optically coupled to the first light source and is configured to collimate light emitted by the first light source to provide a first beam of collimated light. The assembly includes an aperture and a holder, wherein the holder holds the second light source in a position such that the second light source emits light through the aperture. In addition, the assembly is adjustable relative to the second lens. The second lens is optically coupled to the aperture and is configured to collimate light emitted by the second light source through the aperture to provide a second beam of collimated light. The camera may be focused at infinity, and at least the first lens and the second lens are within a field of view of the camera.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1A is a sectional view of a LIDAR device that includes a transmitter and a receiver, according to an example embodiment.

FIG. 1B is a sectional view of the LIDAR device of FIG. 1A that shows light being emitted from the transmitter into an environment of the LIDAR device, according to an example embodiment.

FIG. 1C is a sectional view of the LIDAR device of FIG. 1A that shows light from the environment of the LIDAR device being received by the receiver, according to an example embodiment

FIG. 2A illustrates a vehicle, according to an example embodiment.

FIG. 2B illustrates a vehicle, according to an example embodiment.

FIG. 2C illustrates a vehicle, according to an example embodiment.

FIG. 2D illustrates a vehicle, according to an example embodiment.

FIG. 2E illustrates a vehicle, according to an example embodiment.

FIG. 3 is a sectional side view of a transmitter and a receiver for a LIDAR device, according to an example embodiment.

FIG. 4 is a front view of the transmitter and receiver shown in FIG. 3, according to an example embodiment.

FIG. 5 is an exploded view of the receiver shown in FIG. 3, according to an example embodiment.

FIG. 6 shows an aperture plate of the receiver shown in FIGS. 4 and 5, according to an example embodiment.

FIG. 7 schematically illustrates an arrangement for aligning the receiver with the transmitter, according to an example embodiment.

FIG. 8A illustrates an image indicating that the receiver is not properly aligned with the transmitter, according to an example embodiment.

FIG. 8B illustrates an image indicating that the receiver is properly aligned with the transmitter, according to an example embodiment.

FIG. 9A illustrates an image showing a beam profile of transmit light at the transmit lens, according to an example embodiment.

FIG. 9B illustrates an image showing a beam profile of transmit light at the transmit lens, according to an example embodiment.

FIG. 10 schematically illustrates an arrangement for aligning the receiver with the transmitter, according to an example embodiment.

FIG. 11 is a flowchart of a method, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

A LIDAR device includes a light transmitter configured to transmit light into an environment of the LIDAR device via one or more optical elements in a transmit path (e.g., a transmit lens, a rotating mirror, and an optical window) and a light receiver configured to detect via one or more optical elements in a receive path (e.g., the optical window, the rotating mirror, a receive lens, and an aperture) light that has been transmitted from the transmitter and reflected by an object in the environment. The light transmitter can include, for example, a laser diode that emits light that diverges along a fast axis and a slow axis. The laser diode can be optically coupled to a fast-axis collimator (e.g., a cylindrical lens or an acylindrical lens) that collimates the fast axis of the light emitted by the laser diode to provide partially-collimated transmit light. The light receiver can include, for example, a silicon photomultiplier (SiPM) that receives light through an aperture (e.g., a pinhole aperture). With this arrangement, it is expected that the light transmitter and light receiver are aligned relative to each other such that the light from the light transmitter can go through the transmit path into the environment of the LIDAR device and then be reflected by an object in the environment back into the LIDAR device and received by the light receiver through the receive path. If, however, the light transmitter and light receiver are incorrectly aligned relative to each other, then the transmit light from the light transmitter might go through the transmit path into the environment in a direction such that only a portion of (or none of) the reflected light from an object in the environment can reach the light receiver.

The light transmitter and light receiver can be aligned before they are mounted in the LIDAR device. To facilitate alignment, the aperture can be mounted in the receiver so as to be adjustable relative to the receive lens. For example, the receiver can include a holder that is configured to mount an aperture plate that includes the aperture and a light sensor board that includes a light sensor (e.g., a SiPM). The holder can include pins that fit into corresponding holes in the aperture plate such that the aperture is aligned with the light sensor when mounted on the holder. The holder and aperture plate can be moved together as an assembly relative to the receive lens.

In an example alignment procedure, a light source, such as a light emitting diode (LED), is mounted on the holder instead of the light sensor. This light source may be in the position normally occupied by the light sensor. The light source emits light through the aperture, so that light emitted is through the receive lens. A camera, or another device configured to record light emitted by the light source, is positioned so that both the transmitter and the receiver are within the field of view of the camera. The camera may, for example, be focused at infinity or focused at a maximum working distance of the LIDAR device. The camera is used to obtain one or more images while light is emitted by both the transmitter and the receiver. The images can include a first spot indicative of light from the transmitter and a second spot indicative of light from the receiver. The holder and aperture are moved together as an assembly until the receiver is aligned with the transmitter (e.g., as indicated by the camera obtaining an image in which the two spots overlap). The light source mounted on the holder can then be replaced by the light sensor, and the now-aligned transmitter and receiver can be mounted in a LIDAR device.

### II. Example LIDAR Device

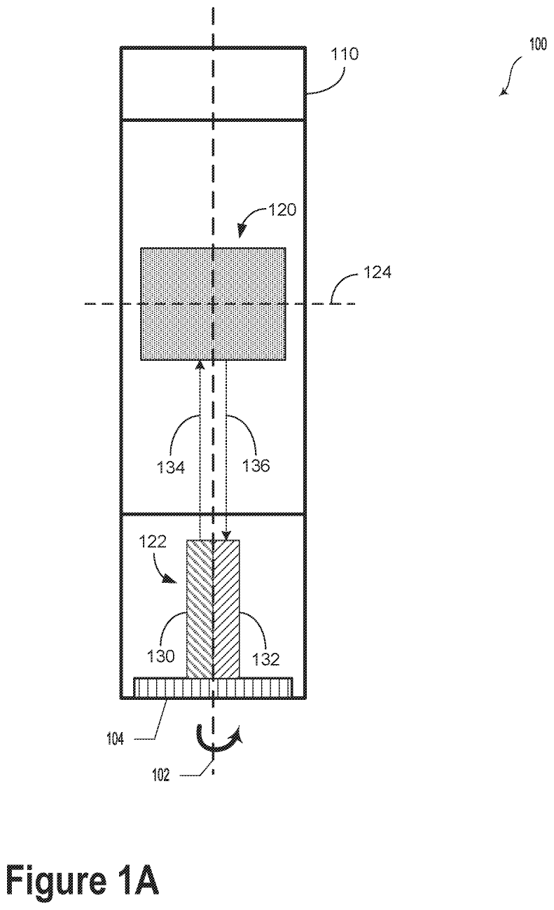

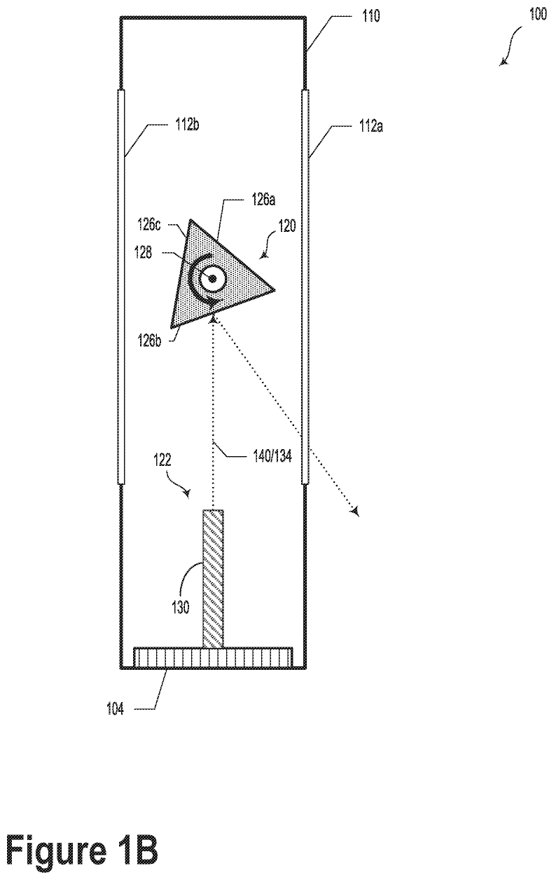

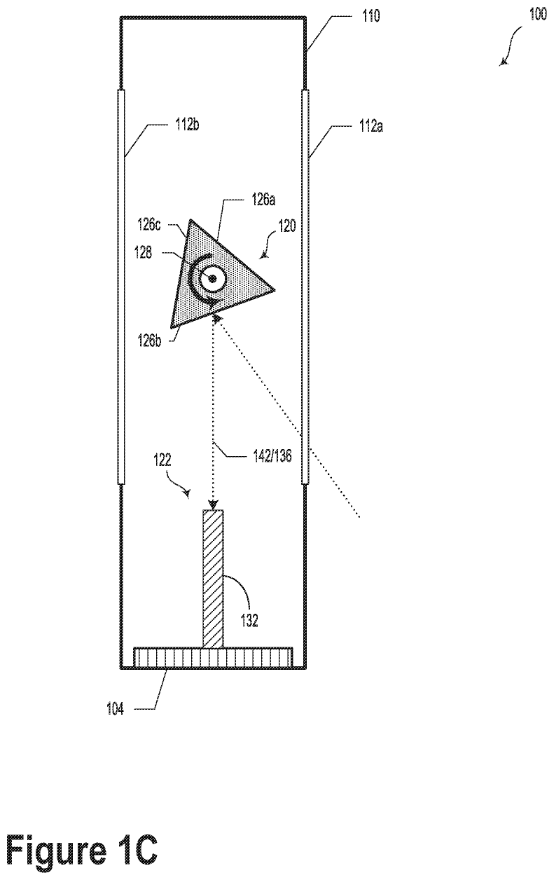

FIGS. 1A, 1B, and 1C illustrate an example LIDAR device 100. In this example, LIDAR device 100 has a device axis 102 and is configured to rotate about the device axis 102 as indicated by the arcuate arrow. The rotation could be provided by a rotatable stage 104 coupled to or included within the LIDAR device 100. In some embodiments, the rotatable stage 104 could be actuated by a stepper motor or another device configured to mechanically rotate the rotatable stage 104.

FIG. 1A is a sectional view of the LIDAR device 100 through a first plane that includes device axis 102. FIG. 1B is a sectional view of the LIDAR device 100 through a second plane that is slightly offset from a plane rotated 90 degrees with respect to the first plane about device axis 102, such that the second plane goes through a transmitter in the LIDAR device 100. FIG. 1C is a sectional view of the LIDAR device 100 through a third plane that is slightly offset from a plane rotated 90 degrees with respect to the first plane about device axis 102, such that the third plane goes through a receiver in the LIDAR device 100.

The LIDAR device 100 includes a housing 110 with optically transparent windows 112a and 112b. A. mirror 120 and an optical cavity 122 are located within the housing 110. The mirror 120 is configured to rotate about a mirror axis 124, which may be substantially perpendicular to device axis 102. In this example, mirror 120 includes three reflective surfaces 126a, 126b, 126c that are coupled to a rotating shaft 128. Thus, as shown in FIGS. 1B and 1C, mirror 120 is generally in the shape of a triangular prism. It is to be understood, however, that mirror 120 could be shaped differently and could have a different number of reflective surfaces.

The optical cavity 122 is configured to emit transmit light toward the mirror 120 for reflection into an environment of the LIDAR device 100 (e.g., through windows 112a and 112b). The optical cavity 122 is further configured to receive light from the environment (e.g., light that enters the LIDAR device 100 through windows 112a and 112b) that has been reflected by the mirror 120. The light received from the environment can include a portion of the light transmitted from the optical cavity 122 into the environment via the mirror 120 that has reflected form one or more objects in the environment.

As shown in FIG. 1A, the optical cavity 122 includes a transmitter 130 and a receiver 132. The transmitter 130 is configured to provide transmit light along a first optical path 134 toward mirror 120. The receiver 132 is configured to receive light from the mirror 120 along a second optical path 136. The optical paths 134 and 136 are substantially parallel to one another, such that receiver 132 can receive along the second optical path 136 reflections from one or more objects in the environment of the transmit light from the transmitter 140 that is provided along the second optical path 134 and then reflected by the mirror 120 into the environment (e.g., through windows 112a and 112b). The optical paths 134 and 136 can be parallel to (or substantially parallel to) the device axis 102. In addition, the device axis 102 could be coincident with (or nearly coincident with) the first optical path 134 and/or the second optical path 136.

In an example embodiment, the transmitter 130 includes a light source that emits light (e.g., in the form of pulses) and a transmit lens that collimates the light emitted from the light source to provide collimated transmit light along the first optical path 134. The light source could be, for example, a laser diode that is optically coupled to a fast-axis collimator. However, other light sources could be used. FIG. 1B shows an example in which collimated transmit light 140 is emitted from the transmitter 130 along the first optical path 134 toward the mirror 120. In this example, the collimated transmit light 140 is reflected by reflective surface 126b of the mirror 120 such that the collimated transmit light 140 goes through optical window 112a and into the environment of the LIDAR device 100.

In an example embodiment, the receiver 132 includes a receive lens, an aperture, and a light sensor. The receive lens is configured to receive collimated light along the second optical path 136 and focus the received collimated light at a point that is located within the aperture. The light sensor is positioned to receive light that diverges from the aperture after being focused by the receive lens. FIG. 1C shows an example in which received light 142 is received through optical window 112a from the environment and then reflected by reflective surface 126b of the mirror 120 toward the receiver 132 along the second optical path 136.

The received light 142 shown in FIG. 1C may correspond to a portion of the transmit light 140 shown in FIG. 1B that has been reflected by one or more objects in the environment. By transmitting the transmit light 140 in the form of pulses, the timing of pulses in the received light 142 that are detected by the light sensor in the receiver 132 can be used to determine distances to the one or more objects in the environment that reflected the pulses of transmit light. In addition, directions to the one or more objects can be determined based on the orientation of the LIDAR device 100 about the device axis 102 and the orientation of the mirror 120 about the mirror axis 124 at the time the light pulses are transmitted or received.

The transmitter 130 and the receiver 132 may be aligned with one another such that the transmit light 140 can be reflected by an object in the environment to provide received light 142 that enters the LIDAR device 100 (e.g., through windows 112a, 112b), is received by the receive lens in the receiver 132 (via the mirror 120 and the second optical path 136), and focused at a point within the aperture for detection by the light sensor. This helps to reliably determine distances and directions. For example, if the aperture in the receiver 132 is misaligned, then the receive lens may focus the received light 142 to a point that is not within the aperture, with the result that the light sensor may be unable to detect the received light 140. To facilitate their alignment, the transmitter 130 and the receiver 132 may be configured as described below. In addition, described below are methods that can be used to align the receiver 132 with the transmitter 130 before the optical cavity 122 is mounted in the LIDAR device 100.

### III. Example Vehicles

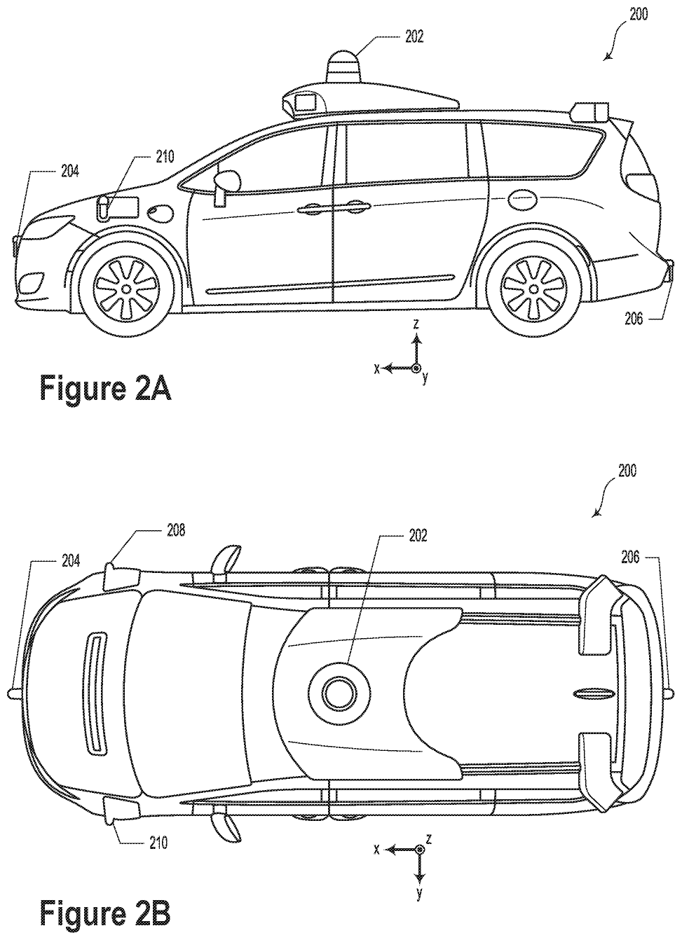

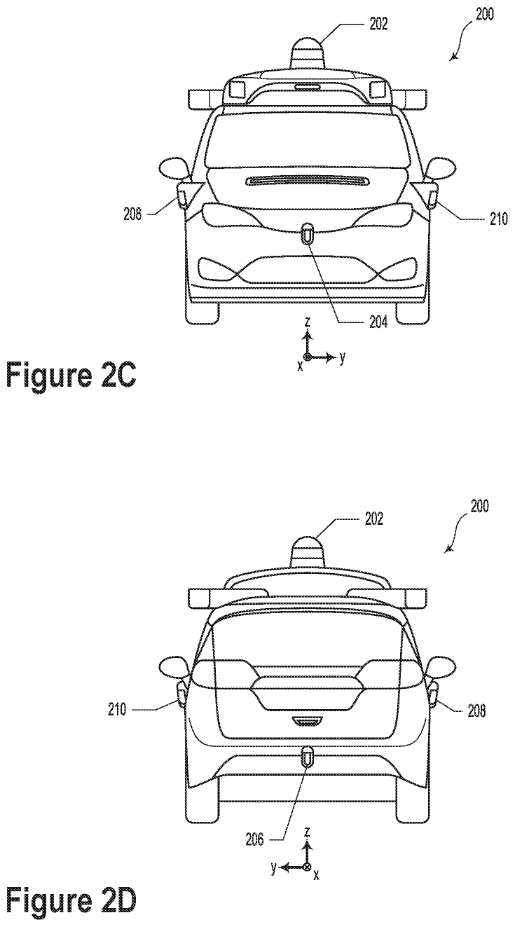

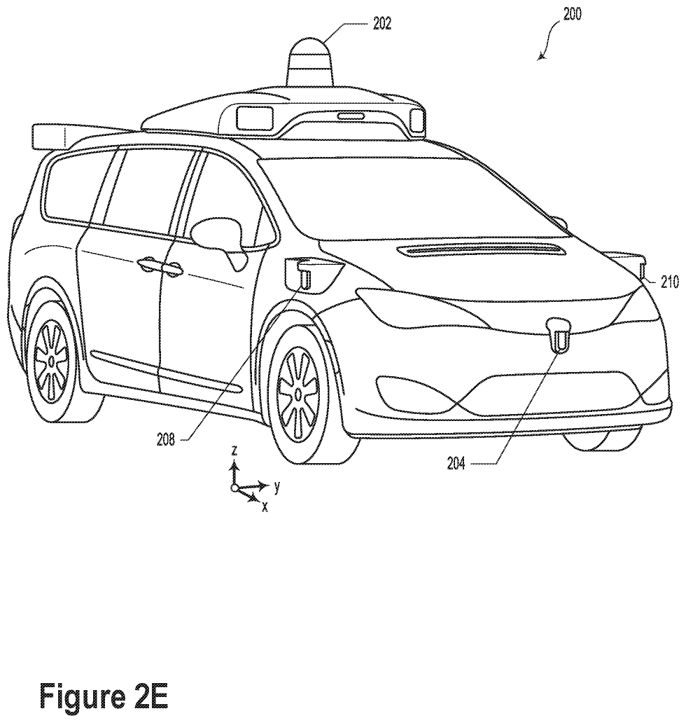

FIGS. 2A-2E illustrate a vehicle 200, according to an example embodiment. The vehicle 200 could be a semi- or fully-autonomous vehicle. While FIGS. 2A-2E illustrates vehicle 200 as being an automobile (e.g., a van), it will be understood that vehicle 200 could include another type of autonomous vehicle, robot, or drone that can navigate within its environment using sensors and other information about its environment.

The vehicle 200 may include one or more sensor systems 202, 204, 206, 208, and 210. In example embodiments, sensor systems 202, 204, 206, 208, and 210 each include a respective LIDAR device. In addition, one or more of sensor systems 202, 204, 206, 208, and 210 could include radar devices, cameras, or other sensors.

The LIDAR devices of sensor systems 202, 204, 206, 208, and 210 may be configured to rotate about an axis (e.g., the z-axis shown in FIGS. 2A-2E) so as to illuminate at least a portion of an environment around the vehicle 200 with light pulses and detect reflected light pulses. Based on the detection of reflected light pulses, information about the environment may be determined. The information determined from the reflected light pulses may be indicative of distances and directions to one or more objects in the environment around the vehicle 200. For example, the information may be used to generate point cloud information that relates to physical objects in the environment of the vehicle 200. The information could also be used to determine the reflectivities of objects in the environment, the material composition of objects in the environment, or other information regarding the environment of the vehicle 200.

The information obtained from one or more of systems 202, 204, 206, 208, and 210 could be used to control the vehicle 200, such as when the vehicle 200 is operating in an autonomous or semi-autonomous mode. For example, the information could be used to determine a route (or adjust an existing route), speed, acceleration, vehicle orientation, braking maneuver, or other driving behavior or operation of the vehicle 200.

In example embodiments, one or more of systems 202, 204, 206, 208, and 210 could be a LIDAR device similar to LIDAR device 100 illustrated in FIGS. 1A-1C.

### IV. Example Transmitter and Receiver Configuration

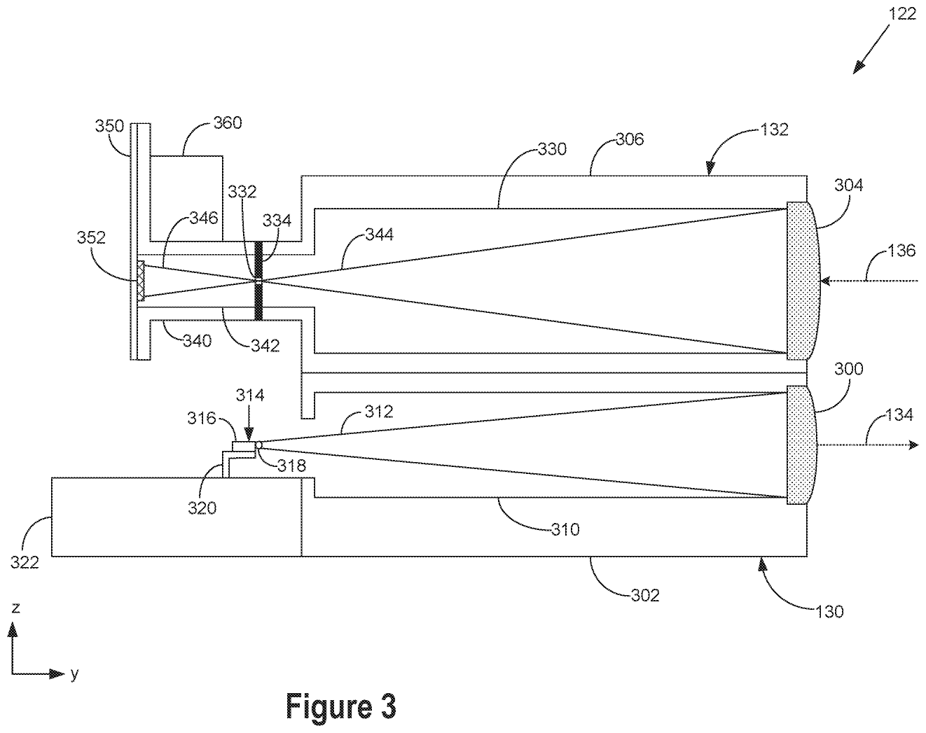

FIG. 3 illustrates (in a sectional side view) an example configuration of optical cavity 122, showing components of transmitter 130 and receiver 132. In this example, transmitter 130 includes a transmit lens 300 mounted to a transmit lens tube 302, and receiver 132 includes a receive lens 304 mounted to a receive lens tube 306. In FIG. 3, the transmit lens tube 302 and the receive lens tube 306 are shown as joined together. It is to be understood, however, that the tubes 302 and 306 could be spaced apart, or they could be integral to a housing of optical cavity 122.

The transmit lens tube 302 has an interior space 310 within which emission light 312 emitted from a light source 314 can reach the transmit lens 300. The transmit lens 300 is configured to at least partially collimate the emission light 312 to provide transmit light (e.g., collimated transmit light) along a first optical axis 134. As shown in FIG. 3, the light source 314 includes a laser diode 316 that is optically coupled to a fast-axis collimator 318. The laser diode 316 could include a plurality of laser diode emission regions and may be configured to emit near-infrared light (e.g., light with a wavelength of approximately 905 nm). The fast-axis collimator 318 may be a cylindrical or acylindrical lens that is either attached to or spaced apart from the laser diode 316. It is to be understood, however, that other types of light sources could be used and that such light sources could emit light at other wavelengths (e.g., visible or ultraviolet wavelengths).

The light source 314 could be mounted on a mounting structure 320 in a position at or near a focal point of the transmit lens 300. The mounting structure 320 could be supported by a base 322 that is attached to the transmit lens tube 302.

The receive lens tube 306 has an interior space 330. The receive lens 304 is configured to receive light (e.g., collimated light transmitted from transmit lens 300 that has been reflected by an object in the environment) along the second optical axis 136 and focus the received light. An aperture 332 is disposed relative to the receive lens 304 such that light focused by the receive lens 304 diverges out of the aperture 332. In particular, the aperture 332 is disposed proximate to the focal plane of the receive lens 304. In the example shown in FIG. 3, a focal point of the receive lens 304 is located within the aperture 332. In this example, aperture 332 is an opening formed in an aperture plate 334 composed of an opaque material. More particularly, the aperture 332 could be a small, pinhole-sized aperture with a cross-sectional area of between 0.02 mm² and 0.06 mm² (e.g., 0.04 mm²). However, other types of apertures are possible and contemplated herein. Further, while the aperture plate 334 is shown with only a single aperture, it is to be understood that multiple apertures could be formed in the aperture plate 334.

The aperture plate 334 is sandwiched between receive lens tube 306 and a holder 340. The holder 340 has an interior space 342 within which light diverges from the aperture 332 after being focused by the receive lens 304. Thus, FIG. 3 shows converging light 344 in the interior space 330, representing light focused by the receive lens 300 to the focal point within the aperture 332, and diverging light 346 extending from the aperture 332 within the interior space 342.

A sensor board 350, on which a light sensor 352 is disposed, is mounted to the holder 340 such that the light sensor 352 is within the interior space 342 and can receive at least a portion of the diverging light 346. The light sensor 352 could include one or more avalanche photodiodes (APDs), single-photon avalanche diodes (SPADs), or other types of light detectors. In an example embodiment, light sensor 352 is a Silicon Photomultiplier (SiPM) that includes a two-dimensional array of SPADs connected in parallel. The light sensitive area of the light sensor 352 could be larger than the size of aperture 332.

Advantageously, the light sensor 352 is aligned relative to the holder 340 by shaping the holder 340 such that the holder 340 directly constrains the position of the light sensor 352 when the board 350 is attached. Alternatively, the light sensor 352 may be precisely positioned on the board 350 and the board 350 and/or holder 340 may include features that align the board 350 relative to the holder 340.

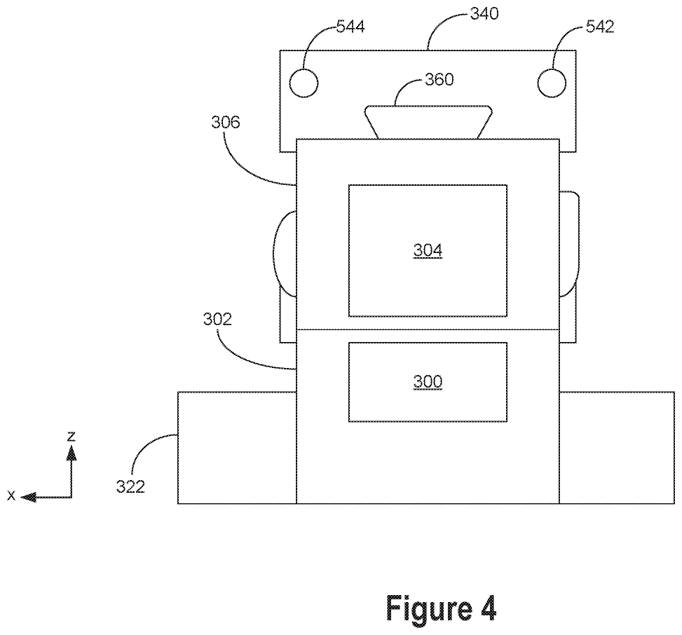

FIG. 4 is a front view of the example configuration of optical cavity 122 shown in FIG. 3. As shown in FIG. 4, the transmit lens 300 and the receive lens 304 may each have a rectangular shape. The interior spaces 310 and 330 of lens tubes 302 and 306, respectively, can have corresponding rectangularly-shaped cross sections.

As shown in FIGS. 3 and 4, holder 340 has an upwardly-extending protrusion 360. As described in more detail below, an adjustment arm can hold the holder 340 by gripping onto the protrusion 360 during an alignment procedure in which the adjustment arm can move the holder 340 and the aperture plate 334 (including the aperture 332) together as an assembly relative to the receive lens 304. More particularly, the adjustment arm can move the holder 340 and aperture plate 334 in the x and z directions indicated in FIG. 4.

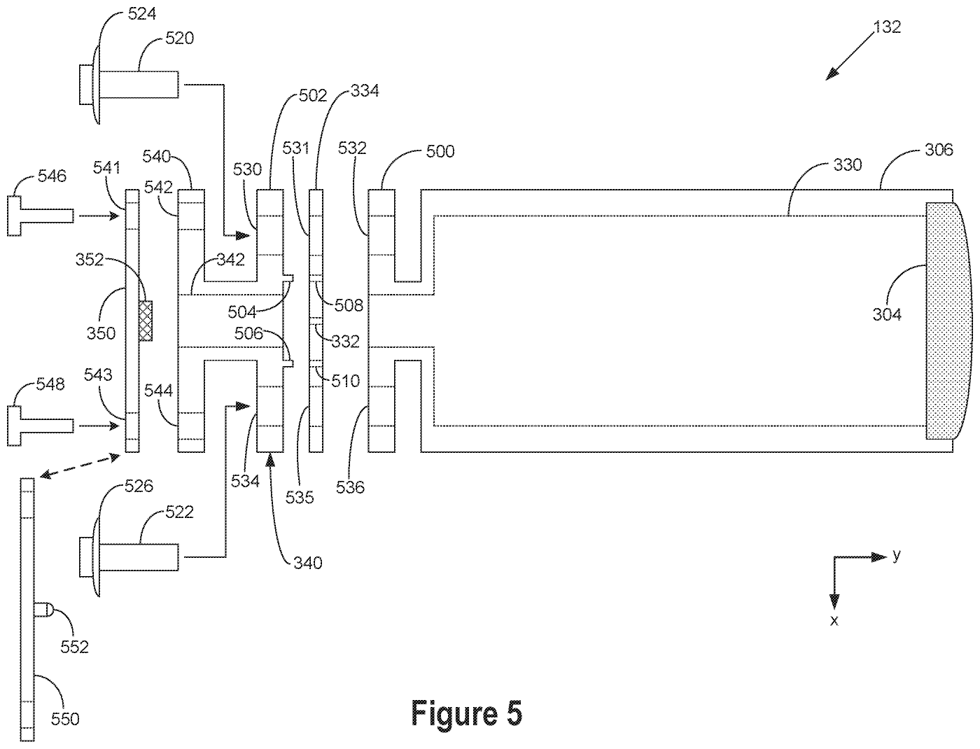

FIG. 5 is an exploded sectional view of the receiver 130 (the sectioning plane is perpendicular to the z-axis indicated in FIGS. 3 and 4) that shows how some of its components could be connected together. In this example, the receive lens tube 306 has a flange 500 that can be connected to a corresponding flange 502 of the holder such that the aperture plate 334 is sandwiched in between. More particularly, the flange 502 of holder 340 includes mounting pins 504 and 506 that fit within corresponding holes 508 and 510 in the aperture plate 334. In this way, the aperture plate 334 can be removably mounted onto the holder 340 such that the aperture 324 is at a well-defined position with respect to the interior space 342 of the holder (e.g., such that the aperture 332 is precisely aligned with the center line of interior space 342). With the aperture plate 334 mounted on the holder 340, the holder 340 and the aperture 332 can be moved together as an assembly relative to the receive lens 304 in an alignment process for aligning the receiver 132 with the transmitter 130.

Once the desired alignment has been achieved, the holder 340 with the aperture plate 334 mounted thereon can be immobilized relative to the receive lens tube 306. This may be achieved by means of screws 520 and 522 with corresponding washers 524 and 526. Specifically, screw 520 goes through mounting holes 530, 531, and 532 in flange 502, aperture plate 334, and flange 500, respectively, and screw 522 goes through mounting holes 533, 534, and 535 in flange 502, aperture plate 334, and flange 500, respectively.

Mounting holes 532 and 536 could be threaded holes that mate with corresponding threads on the shafts of screws 520 and 522, respectively. In example embodiments, mounting holes 530, 531, 534, and 535 are larger than the shafts of the screws 520 and 522 so that the holder 340 and aperture 332 can be moved together within a range of positions relative to the flange 500 (e.g., a range of positions in the x and z directions) that still enables the screws 520 and 522 to be received into the mounting holds 532 and 536 of the flange 500. This configuration allows for a range of motion of the holder 340 and aperture 332 with respect to the receive lens 304 (e.g., during the alignment process) that could be less than 1 millimeter or could be several millimeters or even greater, depending on the implementation. in this configuration, the range of motion is in a plane. In an alternative configuration, the range of motion could be spherical, such as by using spherical surfaces on flanges 500 and 502 with the sphere centered on the receive lens 304. The range of motion could have other shapes as well.

FIG. 5 also shows how sensor board 350 with light sensor 352 disposed thereon can be mounted to the holder 340. Holder 340 includes a flange 540 (located on an opposite side of the holder 340 from flange 502). The flange 540 and the sensor board 350 each include mounting holes to allow the sensor board 350 to be mounted to the flange 540 by means of screws, exemplified in FIG. 5 by screws 546 and 548. Specifically, screw 546 goes through mounting holes 541 and 542 in sensor board 350 and flange 540, respectively, and screw 548 goes through mounting holes 543 and 544 in sensor board 350 and flange 540, respectively.

FIG. 5 also shows a light emitter board 550 that can be mounted to the flange 540 of the holder 340 instead of the light sensor board 350 (e.g., using screws 546 and 548). A light source 552 is disposed on the light emitter board 550. The light source 552 could include a light emitting diode (LED), a laser diode, or any other light source that emits light at the same or similar wavelengths as emitted by light source 314.

When the light emitter board 550 is mounted on flange 540 of holder 340, the light source 552 is positioned in the interior space 342 such that the light source 552 is able to emit light through the aperture 332. The light emitted through the aperture 332 is collimated by receive lens 304 and transmitted out of the receiver 132 as a beam of collimated light. When the receiver 132 is properly aligned with the transmitter 130, the beam of collimated light is transmitted out of the receiver 132 along the second optical axis 136.

As described in more detail below, an example alignment process can use both light source 314 and light source 552, with light from the light source 314 being emitted through transmit lens 300 as a first beam of collimated light and light from the light source 552 being emitted through receive lens 302 as a second beam of collimated light. When the first and second beams of collimated light overlap (e.g. as indicated by an image obtained by a camera), then the receiver 132 is properly aligned with the transmitter 130.

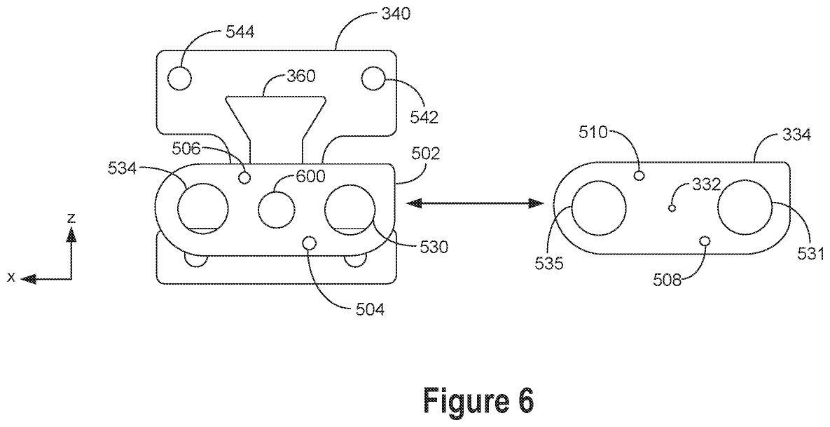

FIG. 6 shows a view of the holder 340 along the y-axis. This view shows flange 502 with an opening 600 into the interior space 342, FIG. 6 also shows the aperture plate 334 that can be removably mounted on flange 502 by means of pins 504 and 506 on flange 502 that fit into corresponding holes 508 and 510 in the aperture plate 334. As shown in FIG. 6, holes 508 and 510 are circular. Alternatively, holes 508 and 510 could have elongated shapes (e.g., holes 508 and 510 could be slots). With the aperture plate 334 mounted on flange 502 in this way, the aperture 332 is centered over the opening 600.

FIGS. 3-6 show examples of structures such as flanges, pins, screws, washers, and mounting holes that may be used to removably attach various components of the receiver 132. It is to be understood that other fasteners or means of attachment could be used. Further, instead of attaching components in a removable fashion, components could be attached in a permanent fashion, for example, using welding, brazing, soldering, or adhesives (such as epoxy).

### V. Example Alignment Techniques

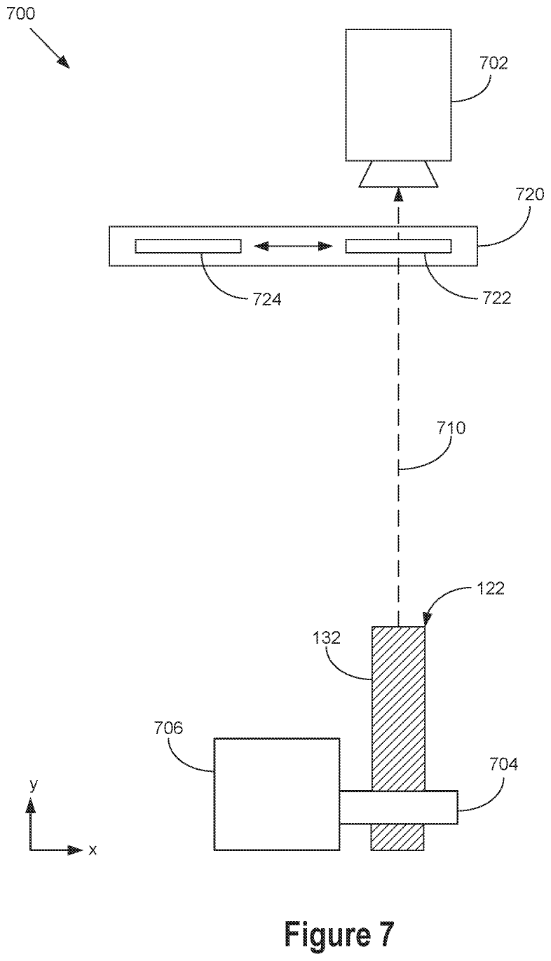

FIG. 7 schematically illustrates an arrangement 700 that can be used to align the receiver 132 with the transmitter 130. The arrangement 700 includes a camera 702 that is positioned such that the optical cavity 122 is within the field of view of the camera 702. The camera 702 could be focused at infinity, or the camera 702 could be focused at a predetermined distance such as the maximum working distance of the LIDAR device. For the alignment process, the light emitter board 550 with light source 552 is mounted on flange 540 of holder 340, as described above, and the aperture plate 334 is mounted on flange 502 of holder 340. However, the holder 340 with the light emitter board 550 and aperture 332 mounted thereto is not attached to the receive lens tube 306. Specifically, the screws 520 and 522 are either not in place or in place only loosely. The holder 340 is supported by an adjustment arm 704 in a position in which the aperture plate 334 mounted on the holder 340 is in contact with flange 500 of the receive lens tube 306. The adjustment arm 704 may support the holder 340 by gripping the protrusion 360.

The adjustment arm 704 is coupled to an adjustment stage 706 that can adjust the position of the adjustment arm 704 and thereby adjust the holder 340 and the aperture 332 in the x and z directions. In this way, the holder 340 and aperture 332 can be adjusted relative to the receive lens 304. For example, the position of the aperture 332 can be adjusted within the focal plane of the receive lens 304. This adjustment can be used to align the receiver 132 with the transmitter 130.

In an example alignment process, light sources 314 and 552 are both used to emit light, with the light source 314 emitting light that is collimated by transmit lens 300 to provide a first beam of collimated light and the light source 552 emitting light through the aperture 332 that is collimated by receive lens 304 to provide a second beam of collimated light. The first and second beams of collimated light are generally indicated in FIG. 7 by the dashed line 710 going from the optical cavity 122 to the camera 702.

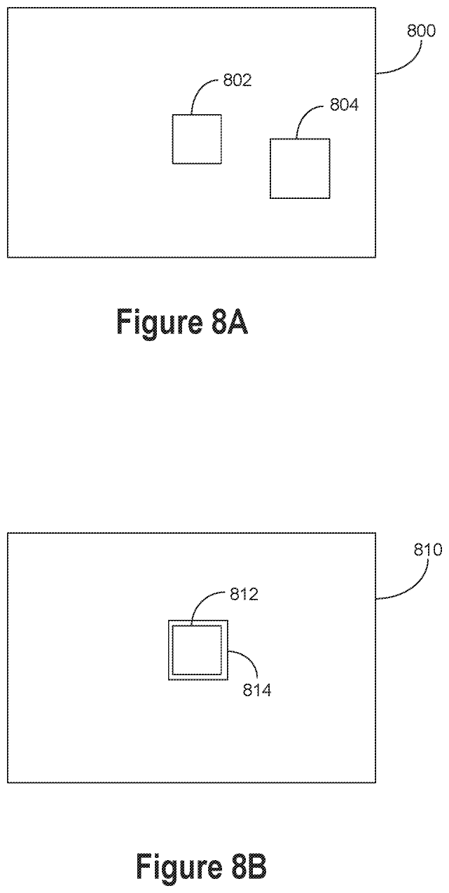

The camera 702 can be used to obtain a series of images in which the first and second beams of collimated light are indicated by respective spots in the images. FIGS. 8A and 8B illustrate example images that may be obtained using camera 702 in the arrangement shown in FIG. 7. FIG. 8A illustrates an example image 800 that includes a spot 802 indicative of the first beam of collimated light from the transmitter 130 and a spot 804 indicative of the second beam of collimated light from the receiver 132. In this image 800, the spots 802 and 804 do not overlap, which indicates that the receiver 132 is not properly aligned with the transmitter 130. Further, the offset between the spots 802 and 804 (e.g., the distance between the center points of the spots 802 and 804) may indicate an extent of the misalignment.

Based on this offset, the position of the aperture 332 can be adjusted using the adjustment stage 706. The camera 702 can be used to obtain one or more subsequent images, and the position of the aperture 332 can be adjusted using the adjustment stage to reduce the offset between the spots in the subsequent images. The adjustment may be continued until the spots partially or completely overlap. FIG. 8B illustrates an example image 810 in which the spots completely overlap. In this image 810, spot 812 (indicative of the first beam of collimated light from the transmitter 130) is encompassed within spot 814 (indicative of the second beam of collimated light from the receiver 132).

In some implementations, image 800 may be obtained by camera 702 as a single image that shows both spot 802 and spot 804. Similarly, image 810 may be obtained by camera as a single image that shows both spot 812 and spot 814. In other implementations, image 800 may be a composite image that is generated from two images obtained by camera 702, with the two images including a first image that shows spot 802 and a second image that shows spot 804. Similarly, image 810 may be a composite image that is generated from two images obtained by camera 702, with one of the images showing spot 812 and the other image showing spot 814.

When the spots completely overlap (e.g., as shown in FIG. 8B), the receiver 132 may be considered to be properly aligned with the transmitter 130. At that point, screws 520 and 522 may be tightened (e.g., tightened to a predetermined torque) to attach the holder 340 to the receive lens tube 306 with the aperture plate 334 sandwiched in between, so as to maintain the position of the aperture 332 relative to the receive lens 304 that was found to align the receiver 132 with the transmitter 130. The light emitter board 550 can then be replaced with the light sensor board 350, and the now-aligned optical cavity 122 can be mounted in a LIDAR device.

In example embodiments, the holder 340 and aperture 332 could remain adjustable after being mounted in the LIDAR device. Specifically, the configuration shown in FIGS. 3-6 enables the position of the aperture 332 to be readjusted at a later time (e.g., by loosening screws 520 and 522). Such readjustment could be performed, for example, if the transmitter 130 and receiver 132 become misaligned after a certain period of use.

Although a complete overlap of the spots (e.g., as shown in FIG. 8B) is one possible criterion for determining that the receiver 132 is properly aligned with the transmitter 130, it is to be understood that other criteria are possible as well. For example, a partial overlap of the spots or a predetermined small offset between non-overlapping spots may indicate sufficient alignment for certain applications. Further, it is to be understood that the adjustment of the holder 340 and aperture 332 that results in alignment of the receiver 132 with the transmitter 130 may be dependent on the particular distance at which the camera 702 is positioned relative to the optical cavity 122.

In some implementations, the receiver 132 may be properly aligned with the transmitter 130 when the two spots do not completely overlap but instead are offset from one another by a predetermined amount. For example, a LIDAR device may include an optical element that deflects light transmitted from the transmitter 130 differently than light received by the receiver 132. In such implementations, the alignment process may be performed to achieve a predetermined offset between the two spots rather than to achieve a complete overlap of the two spots.

The camera 702 could also be used to evaluate other aspects of the optical cavity 122. For example, the camera 702 could be used to evaluate a beam profile of the first beam of collimated light (transmit light) relative to the transmit lens 300. To perform an evaluation of the beam profile, the camera 702 may be focused on the transmit lens 300 while the light source 314 emits light. At this focus, the camera can also be used to identify dirt on the lens 300.

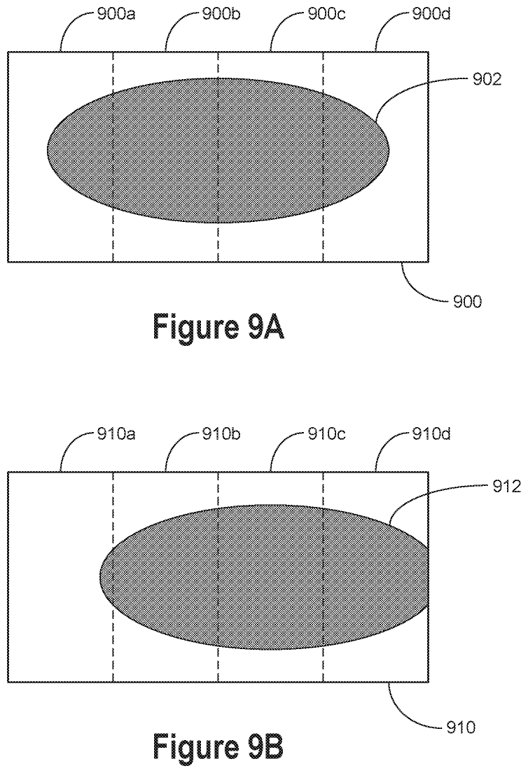

FIGS. 9A and 9B illustrate example images of the transmit lens 300 that could be obtained using camera 702, showing two different beam profiles. FIG. 9A illustrates an image 900 with a spot 902 indicating the position of the transmit light at the transmit lens 300, in accordance with a first example. In this first example, the spot 902 is generally centered within the image 900, indicating that the transmit light is generally centered at the transmit lens 300. FIG. 9B illustrates an image 910 with a spot 912 indicating the position of the transmit light at the transmit lens 300, in accordance with a second example. In this second example, the spot 912 is not centered within the image 910 but is instead shifted to one side. Thus, in this second example, the transmit light is not centered at the transmit lens 300. In response to a determination that the transmit light is not sufficiently centered at the transmit lens 300 (e.g., as shown in FIG. 9B), the light source 314 could be adjusted or replaced.

One or more metrics could be used to evaluate whether the transmit light is sufficiently centered at the transmit lens 300. In one approach, the light intensities within different portions of the image could be determined and compared. For example, the light intensities in portions 900a-d of image 900 could be determined and the light intensities in portions 910a-d of image 910 could be determined. If the difference between the intensities in the two outermost portions is sufficiently small (e.g., when normalized by the total or average intensity), then the first beam of collimated light may be deemed sufficiently centered at the transmit lens 300. For example, the difference between the light intensity in portions 900a and 900d of image 900 may be relatively small, such that the first beam of collimated light may be deemed sufficiently centered, whereas the difference between the light intensity in portions 910a and 910d of image 910 may be relatively large, such that the first beam of collimated light may be deemed insufficiently centered.

The arrangement 700 shown in FIG. 7 includes a translation stage 720 that can be used to move filters, lenses, and/or other optical components into or out of the field of view of the camera 702 (e.g., while the camera 702 is focused at infinity or other predetermined distance), depending on the type of images being obtained by the camera 702. To obtain images used for aligning the receiver 132 with the transmitter 130 (such as the images shown in FIGS. 8A and 8B), a neutral density filter 722 may be placed in the field of view of the camera 702. In implementations in which composite images are generated from two images, the neutral density filter 722 may be used to obtain both images or may be used to obtain just one of the images. To obtain images used for evaluating the beam profile of the transmit light at the transmit lens 300 (such as the images shown in FIGS. 9A and 9B), an optical arrangement 724 made up of a neutral density filter and one or more lenses (e.g., an achromatic doublet) may be placed in the field of view of the camera 702. The one or more lenses are selected such that the transmit lens 300 is imaged with the camera 702 still being focused at infinity or other predetermined distance.

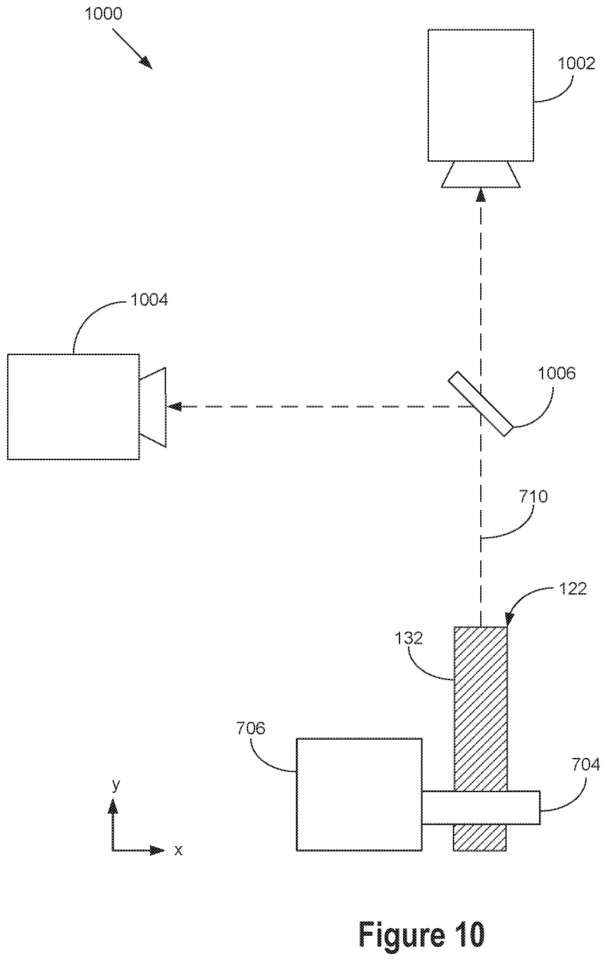

FIG. 10 illustrates an arrangement 1000 that can be used as an alternative to the arrangement 700 illustrated in FIG. 7. In this arrangement 1000, two cameras are used to obtain images. A first camera 1002 is to obtain images for aligning the receiver 132 with the transmitter 130 (such as the images shown in FIGS. 8A and 8B). A second camera 1004 is to obtain images for evaluating the beam profile of the transmit light at the transmit lens 300 (such as the images shown in FIGS. 9A and 9B). The first camera 1002 may be focused at infinity (or other predetermined distance), and the second camera 1004 may be focused on the transmit lens 300. The arrangement 1000 can include an optical element, such as a beamsplitter 1006, that directs a first portion of the light 710 transmitted from the optical cavity 122 (the light 710 includes the first beam of collimated light and the second beam of collimated light) to the first camera 1002 and a second portion of the light 710 to the second camera 1004.

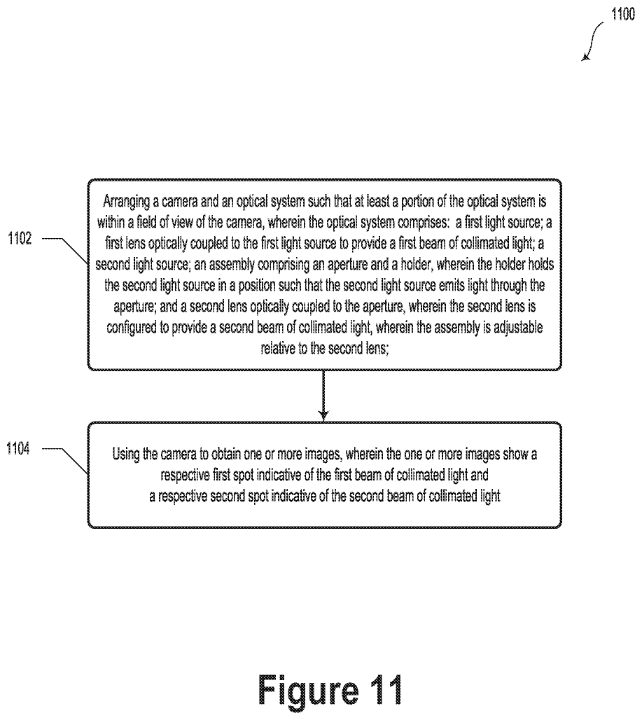

FIG. 11 is a flowchart of an example method 1100 that could be used as part of an overall procedure for fabricating a LIDAR device such as LIDAR device 100 shown in FIGS. 1A-1C. The example method 1100 involves arranging a camera and an optical system such that the optical system is within a field of view of the camera, as indicated by block 1102. The camera could be, for example, a CCD-based camera or other type of digital imaging. device. The optical system could be a component of a LIDAR device, such as the optical cavity 122 with transmitter 130 and receiver 132 shown in FIG. 3-6 and described above. In example embodiments, the optical system includes: a first light source (e.g., light source 314); a first lens e.g, transmit lens 300) optically coupled to the first light source, wherein the first lens is configured to collimate light emitted by the first light source to provide a first beam of collimated light; a second light source (e.g., light source 552); an assembly comprising an aperture (e.g., aperture 332 in aperture plate 334) and a holder (e.g., holder 340), wherein the holder holds the second light source in a position such that the second light source emits light through the aperture; and a second lens (e.g., receive lens 304) optically coupled to the aperture, wherein the second lens is configured to collimate light emitted by the second light source through the aperture to provide a second beam of collimated light, wherein the assembly is adjustable relative to the second lens.

The arrangement of the camera and optical system could correspond to the arrangement shown in FIG. 7, the arrangement shown in FIG. 10, or some other arrangement. In the arrangement, at least a portion of the optical system is in the field of view of the camera. For example, at least transmit lens 300 and receive lens 304 may be within the field of view of the camera, so that the camera can receive both the first beam of collimated light emitted through the transmit lens 300 and the second beam of collimated light emitted through the receive lens 304. The optical system (or portion thereof) may be in the field of view of the camera via one or more optical elements, such as one or more neutral density filters, wavelength-selective filters, lenses, mirrors, beamsplitters, or polarizers. For example, a polarizer may be used to evaluate the polarization properties of the laser diode.

The example method 1100 further involves using the camera to obtain one or more images, wherein the one or more images show a respective first spot indicative of the first beam of collimated light and a respective second spot indicative of the second beam of collimated. light, as indicated by block 1104. In some implementations, the camera may obtain an image that shows both the first spot and the second spot. In other implementations, the camera may obtain a first image that shows the first spot and a second image that shows the second spot, and a composite image may be generated based on the first and second images such that the composite image shows both the first spot and the second spot. Thus, either directly or by way of a composite, an image that shows both the first spot and the second spot may be obtained. In some cases, the image may show that the first and second spots are non-overlapping, such as image 800 shown in FIG. 8A. In other cases, the image show may show that the first and second spots are completely overlapping, such as image 810 shown in FIG. 8B. In still other cases, the image may show that the first and second spots are partially overlapping. The one or more images obtained in this way could be used to align the receiver 132 with the transmitter 130, as described above.

In some embodiments, method 1100 could further involve determining, based on the one or more images obtained by the camera (e.g., based on a composite of two images), an offset between the first spot and the second spot and adjusting the assembly relative to the second lens based on the offset. The adjustment of the assembly could use mechanisms similar to the adjustment arm 704 and adjustment stage 706 illustrated in FIG. 7 and described above.

After adjusting the assembly relative to the second lens based on the offset, method 1100 could further involve using the camera to obtain one or more subsequent images and determining, based on the one or more subsequent images (e.g., based on a composite of two images) that the first and second spots have at least a predetermined overlap. The predetermined overlap could be chosen as complete overlap (e.g., as shown in FIG. 8B) or could be chosen as a certain amount of partial overlap (e.g., at least a 30% overlap, 50% overlap, 70% overlap, or 90% overlap).

After determining that the first and second spots have at least the predetermined overlap in the subsequent image, method 1100 could further involve replacing the second light source (e.g., light source 552 on light emitter board 550) in the holder with a light sensor (e.g., light sensor 352 on light sensor board 350).

After replacing the second light source in the holder with the light sensor, method 1100 could further involve mounting the optical system in a LIDAR device (e.g., LIDAR device 100).

In some embodiments of method 1100, the camera is used to obtain the one or more images while the camera is focused at infinity or at a predetermined distance, such as the maximum range of the LIDAR device.

In some embodiments, method 1100 further involves arranging an additional camera (e.g., camera 1004) relative to the optical system, such that at least the first lens is within a field of view of view of the additional camera, and using the additional camera to obtain at least one image of at least the first lens. In some implementations, the additional camera may be used to obtain an image or images of both the first lens and the second lens (e.g., to inspect for dirt on the lenses).

In embodiments that use an additional camera, method 1100 may further involve determining a beam profile of the first beam of collimated light relative to the first lens based on the at least one image of the first lens. The first light source may include a laser diode and a fast-axis collimator. The laser diode may include a plurality of laser diode emission regions. Alternatively, the beam profile of the first beam of collimated light relative to the first lens could be determined based on at least one image of the first lens obtained by the camera, without using an additional camera.

In embodiments that use an additional camera or other additional device configured to obtain images, the arrangement of the cameras and optical system may be similar to arrangement 1000 shown in FIG. 10, in which both the camera and the additional camera are optically coupled to the optical system via a beamsplitter (e.g., beamsplitter 1006). In an example arrangement using the beamsplitter, at least the first lens and the second lens are within the field of view of the camera via transmission through the beamsplitter and at least the first lens is within the field of view of the additional camera via reflection from the beamsplitter. Alternatively, the camera's field of view may be via reflection from the beamsplitter and the additional camera's field of view may be via transmission through the beamsplitter.

### VI. Conclusion

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

The specification includes the following subject-matter, expressed in the form of clauses 1-20: 1. A light detection and ranging (LIDAR) device, comprising: a transmitter, wherein the transmitter comprises: a laser diode; a fast-axis collimator optically coupled to the laser diode; and a transmit lens optically coupled to the fast-axis collimator, wherein the transmit lens is configured to at least partially collimate light emitted by the laser diode through the fast-axis collimator to provide transmit light along a first optical axis; and a receiver, wherein the receiver comprises: a receive lens, wherein the receive lens is configured to receive light along a second optical axis that is substantially parallel to the first optical axis and focus the received light; a light sensor; and an assembly comprising an aperture and a holder, wherein the aperture is proximate to a focal plane of the receive lens, wherein the holder is configured to hold the light sensor at a position relative to the aperture such that the light sensor receives light that diverges from the aperture after being focused by the receive lens, and wherein the assembly is adjustable relative to the receive lens. 2. The LIDAR device of clause 1, wherein the aperture comprises an opening in an aperture plate, and wherein the aperture plate is removably mounted on the holder. 3. The LIDAR device of clause 1 or 2, wherein the fast-axis collimator comprises at least one of a cylindrical lens or an acylindrical lens. 4. The LIDAR device of any of clauses 1-3, wherein the light sensor comprises an array of single-photon light detectors. 5. The LIDAR device of clause 4, the wherein the array of single-photon light detectors has a light-sensitive area that is larger than the aperture. 6. The LIDAR device of clause 4 or 5, wherein the light sensor comprises a silicon photomultiplier (SiPM). 7. The LIDAR device of any of clauses 1-6, further comprising a mirror, wherein the mirror is configured to (i) reflect the transmit light transmitted from the transmit lens along the first optical axis into an environment of the LIDAR device and (ii) reflect toward the receive lens along the second optical axis reflections of the transmit light from the environment. 8. A method, comprising: arranging a camera and an optical system such that at least a portion of the optical system is within a field of view of the camera, wherein the optical system comprises: a first light source; a first lens optically coupled to the first light source, wherein the first lens is configured to collimate light emitted by the first light source to provide a first beam of collimated light; a second light source; an assembly comprising an aperture and a holder, wherein the holder holds the second light source in a position such that the second light source emits light through the aperture; and a second lens optically coupled to the aperture, wherein the second lens is configured to collimate light emitted by the second light source through the aperture to provide a second beam of collimated light, wherein the assembly is adjustable relative to the second lens; and using the camera to obtain one or more images, wherein the one or more images show a respective first spot indicative of the first beam of collimated light and a respective second spot indicative of the second beam of collimated light. 9. The method of clause 8, further comprising: determining, based on the one or more images, an offset between the first spot and the second spot; and adjusting the assembly relative to the second lens based on the offset. 10. The method of clause 9, further comprising: after adjusting the assembly relative to the second lens based on the offset, using the camera to obtain one or more subsequent images; and determining, based on the one or more subsequent images, that the first and second spots have at least a predetermined overlap. 11. The method of clause 10, further comprising: after determining that the first and second spots have at least the predetermined overlap, replacing the second light source in the holder with a light sensor. 12. The method of clause 11, comprising after replacing the second light source in the holder with the light sensor, mounting the optical system in a light detection and ranging (LIDAR) device. 13. The method of any of clauses 8-12, wherein using the camera to obtain one or more images comprises using the camera to obtain the one or more image while the camera is focused at infinity. 14. The method of clause 13, further comprising: optically coupling an additional lens to the camera such that the camera focuses on the first lens; using the camera focused on the first lens to obtain at least one image of the first lens; and determining a beam profile of the first beam of collimated light relative to the first lens based on the at least one image of the first lens. 15. The method of any of clauses 8-14, further comprising: arranging an additional camera relative to the optical system such that at least the first lens is within a field of view of the additional camera; using the additional camera to obtain at least one image of the first lens; and determining a beam profile of the first beam of collimated light relative to the first lens based on the at least one image of the first lens. 16. The method of clause 15, further comprising: optically coupling the camera and the additional camera to the optical system via a beamsplitter. 17. The method of clause 16, wherein at least the first lens and the second lens are within the field of view of the camera via transmission through the beamsplitter and at least the first lens is within the field of view of the additional camera via reflection from the beamsplitter. 18. A system, comprising: a first light source; a first lens optically coupled to the first light source, wherein the first lens is configured to collimate light emitted by the first light source to provide a first beam of collimated light; a second light source; an assembly comprising an aperture and a holder, wherein the holder holds the second light source in a position such that the second light source emits light through the aperture; a second lens optically coupled to the aperture, wherein the second lens is configured to collimate light emitted by the second light source through the aperture to provide a second beam of collimated light, wherein the assembly is adjustable relative to the second lens; and a camera, wherein at least the first lens and the second lens are within a field of view of the camera, and wherein the camera is focused at infinity. 19, The system of clause 18, further comprising: an additional camera, wherein at least the first lens is within a field of view of the additional camera, and wherein the additional camera is focused on the first lens. 20. The system of clause 19, further comprising: a beamsplitter, wherein the first and second lenses are within the field of view of the camera via transmission through the beamsplitter, and wherein the first lens is within the field of view of the additional camera via reflection from the beamsplitter.

What is claimed is:

1. A light detection and ranging (LIDAR) device, comprising:
a transmitter, wherein the transmitter comprises:
a laser diode;
a fast-axis collimator optically coupled to the laser diode; and
a transmit lens optically coupled to the fast-axis collimator, wherein the transmit lens is configured to at least partially collimate light emitted by the laser diode through the fast-axis collimator to provide transmit light along a first optical axis; and
a receiver, wherein the receiver comprises:
a receive lens, wherein the receive lens is configured to receive light along a second optical axis that is substantially parallel to the first optical axis and focus the received light;
a light sensor; and
an assembly comprising an aperture and a holder, wherein the aperture is proximate to a focal plane of the receive lens, wherein the holder is configured to hold the light sensor at a position relative to the aperture such that the light sensor receives light that diverges from the aperture after being focused by the receive lens, and wherein the assembly is adjustable relative to the receive lens.

2. The LIDAR device of claim 1, wherein the aperture comprises an opening in an aperture plate, and wherein the aperture plate is removably mounted on the holder.

3. The LIDAR device of claim 1, wherein the fast-axis collimator comprises at least one of a cylindrical lens or an acylindrical lens.

4. The LIDAR device of claim 1, wherein the light sensor comprises an array of single-photon light detectors.

5. The LIDAR device of claim 4, the wherein the array of single-photon light detectors has a light-sensitive area that is larger than the aperture.

6. The LIDAR device of claim 4, wherein the light sensor comprises a silicon photomultiplier (SiPM).

7. The LIDAR device of claim 1, further comprising a mirror, wherein the mirror is configured to (i) reflect the transmit light transmitted from the transmit lens along the first optical axis into an environment of the LIDAR device and (ii) reflect toward the receive lens along the second optical axis reflections of the transmit light from the environment.

8. A method, comprising:
arranging a camera and an optical system such that at least a portion of the optical system is within a field of view of the camera, wherein the optical system comprises:
a first light source;
a first lens optically coupled to the first light source, wherein the first lens is configured to collimate light emitted by the first light source to provide a first beam of collimated light;
a second light source;
an assembly comprising an aperture and a holder, wherein the holder holds the second light source in a position such that the second light source emits light through the aperture; and
a second lens optically coupled to the aperture, wherein the second lens is configured to collimate light emitted by the second light source through the aperture to provide a second beam of collimated light, wherein the assembly is adjustable relative to the second lens; and
using the camera to obtain one or more images, wherein the one or more images show a respective first spot indicative of the first beam of collimated light and a respective second spot indicative of the second beam of collimated light.

9. The method of claim 8, further comprising:
determining, based on the one or more images, an offset between the first spot and the second spot; and
adjusting the assembly relative to the second lens based on the offset.

10. The method of claim 9, further comprising:
after adjusting the assembly relative to the second lens based on the offset, using the camera to obtain one or more subsequent images; and
determining, based on the one or more subsequent images, that the first and second spots have at least a predetermined overlap.

11. The method of claim further comprising:
after determining that the first and second spots have at least the predetermined overlap, replacing the second light source in the holder with a fight sensor.

12. The method of claim 11,
after replacing the second light source in the holder with the light sensor, mounting the optical system in a light detection and ranging (LIDAR) device.

13. The method of claim 8, wherein using the camera to obtain one or more images comprises using the camera to obtain the one or more image while the camera is focused at infinity.

14. The method of claim 13, further comprising:
optically coupling an additional lens to the camera such that the camera focuses on the first lens;
using the camera focused on the first lens to obtain at least one image of the first lens; and
determining a beam profile of the first beam of collimated light relative to the first lens based on the at least one image of the first lens.

15. The method of claim 8, further comprising:
arranging an additional camera relative to the optical system such that at least the first lens is within a field of view of the additional camera;
using the additional camera to obtain at least one image of the first lens; and
determining a beam profile of the first beam of collimated light relative to the first lens based on the at least one image of the first lens.

16. The method of claim 15, further comprising:
optically coupling the camera and the additional camera to the optical system via a beamsplitter.

17. The method of claim 16, wherein at least the first lens and the second lens are within the field of view of the camera via transmission through the beamsplitter and at least the first lens is within the field of view of the additional camera via reflection from the beamsplitter.

18. A system, comprising:
a first light source;
a first lens optically coupled to the first light source, wherein the first lens is configured to collimate light emitted by the first light source to provide a first beam of collimated light;
a second light source;
an assembly comprising an aperture and a holder, wherein the holder holds the second light source in a position such that the second light source emits light through the aperture;
a second lens optically coupled to the aperture, wherein the second lens is configured to collimate light emitted by the second light source through the aperture to provide a second beam of collimated light, wherein the assembly is adjustable relative to the second lens; and
a camera, wherein at least the first lens and the second lens are within a field of view of the camera, and wherein the camera is focused at infinity.

19. The system of claim 18, further comprising:
an additional camera, wherein at least the first lens is within a field of view of the additional camera, and wherein the additional camera is focused on the first lens.

20. The system of claim 19, further comprising:
a beamsplitter, wherein the first and second lenses are within the field of view of the camera via transmission through the beamsplitter, and wherein the first lens is within the field of view of the additional camera via reflection from the beamsplitter.
